(19) United States
(12) Patent Application Publication
(10) Pub. No.: US 2026/0093761 A1
(43) Pub. Date: Apr. 2, 2026

(54) APPARATUS FOR PERSONALIZING DOCUMENT SEARCH AND CREATING NEW DOCUMENT WITHIN INSTITUTION USING ARTIFICIAL INTELLIGENCE AND METHOD THEREOF

(71) Applicant: ARCHIVSOFT Co., Ltd., Goyang-si (KR)

(72) Inventor: Ji Sung KIM, Goyang-si (KR)

(73) Assignee: ARCHIVSOFT Co., Ltd., Goyang-si (KR)

(21) Appl. No.: 18/923,871

(22) Filed: Oct. 23, 2024

(30) Foreign Application Priority Data
Oct. 2, 2024 (KR) 10-2024-0134264

(51) Int. Cl. G06F 16/9535

(52) U.S. Cl. CPC G06F 16/9535

(57) ABSTRACT

The present disclosure relates to an apparatus for personalizing document search and creating a new document using artificial intelligence and a method thereof, and according to the present disclosure, and includes obtaining first data including a search history of a user, a document viewing history, department information, and an electronic document through an input module; preprocessing the first data; learning the preprocessed first data; generating a document search personalization and new document creation model using the learning result; obtaining a request message through the input module; generating at least one of a document search result and a new document corresponding to the request message using the document search personalization and new document creation model; and controlling the display to display the generated result.

### CROSS-REFERENCE TO RELATED APPLICATIONS

A claim for priority under 35 U.S.C. § 119 is made to Korean Patent Application No. 10-2024-0134264 filed on Oct. 2, 2024 in the Korean Intellectual Property Office, the entire contents of which are hereby incorporated by reference.

### BACKGROUND

### 1. Technical Field

The present disclosure relates to an apparatus for personalizing document search and creating a new document, and more particularly, to an apparatus for personalizing document search and creating a new document within an institution using artificial intelligence and a method thereof.

### 2. Description of Related Art

With the recent development of information technology, many companies have introduced numerous solutions to improve information efficiency, and this change has recently shown a trend toward integration. Each company has established groupware and an intranet for sharing internal information, and has users access a thin server built within the company using a thin client to perform tasks managed centrally.

In addition, each company has established systems such as enterprise resource planning (ERP), customer relationship management (CRM), and supply chain management (SCM) with the goal of managing various types of information. In addition, as the Internet became active, homepages were established, and B2C (Business-to-Consumer) or B2B (Business-to-Business) systems were established for e-commerce.

And because it was still difficult to find necessary information in the midst of such a flood of systems, an enterprise portal began to spread rapidly, which integrated various types of information inside and outside the company, such as intranet, groupware, enterprise resource planning, customer relationship management, supply chain management, electronic document management systems, and knowledge management systems, into a single interface to provide services tailored to the needs of users, thereby increasing convenience and even work productivity.

However, in the case of the conventional art, there was a problem that users felt inconvenienced because they could only manage various documents in an integrated manner and it was difficult to search for documents and create new documents tailored to the characteristics of individual users.

### SUMMARY

The embodiment disclosed in the present disclosure is to provide an apparatus for document search personalization and new document creation which can provide a search result optimized for each individual by considering a search pattern, an interest, and work characteristics of a user.

The embodiment disclosed in the present disclosure is to provide an apparatus for document search personalization and new document creation which can search and recommend a document needed by a specific user through electronic document learning.

The embodiment disclosed in the present disclosure is to provide an apparatus for document search personalization and new document creation which allows a user to create a new draft document by editing and immediately utilizing the draft document required for a specific task.

Technical problems of the inventive concept are not limited to the technical problems mentioned above, and other technical problems not mentioned will be clearly understood by those skilled in the art from the following description.

In an aspect of the present disclosure, an apparatus for personalizing document search and creating a new document within an institution using artificial intelligence includes an input module configured to acquire data; a communication module configured to transmit and receive the data with an external device; a memory configured to store at least one process for performing an operation and storing user input and data; a display configured to display a graphic image; and a processor configured to perform a control method according to the process, wherein the processor is configured to: obtain first data including a search history of a user, a document viewing history, department information, and an electronic document through the input module, preprocess the first data, learn the preprocessed first data, generate a document search personalization and new document creation model using the learning result, obtain a request message through the input module, generate at least one of a document search result or a new document corresponding to the request message using the document search personalization and new document creation model, and control the display to display the generated result.

In the apparatus for personalizing document search and creating a new document according to the present disclosure, the processor is configured to generate a personal profile based on at least one of the search history of the user, the document viewing history, or the department information, and control the display to display the generated personal profile.

In the apparatus for personalizing document search and creating a new document according to the present disclosure, the processor is configured to generate a recommended document search result by analyzing search patterns of users performing similar tasks, and control the display to display the generated recommended document search result.

In the apparatus for personalizing document search and creating a new document according to the present disclosure, the processor is configured to analyze a keyword and a topic of the document viewed by the user within a predetermined period, and control the display to display the document with a similarity exceeding a threshold based on the analysis result.

In the apparatus for personalizing document search and creating a new document according to the present disclosure, the processor is configured to control the display to display the document with a relevance exceeding a threshold by reflecting recent search history and information on current proceeding project.

In the apparatus for personalizing document search and creating a new document according to the present disclosure, the processor is configured to, based on creating a new document, search for a similar document of which content and similarity to the new document is within a predetermined range or higher, analyze a structure of the searched similar document, and control the display to display a template that reflects the analysis result.

In the apparatus for personalizing document search and creating a new document according to the present disclosure, the processor is configured to search for a related document of which similarity level with the new document is a predetermined range or higher, automatically summarize and cite a core content of the related document, and control the display to display the summary and citation result.

In the apparatus for personalizing document search and creating a new document according to the present disclosure, the processor is configured to search for a related document of which similarity level with the new document is a predetermined range or higher, extract a main keyword of the related document, and control the display to display the extracted main keyword.

In the apparatus for personalizing document search and creating a new document according to the present disclosure, the processor is configured to analyze a context of the document being written, and control the display to display a text message containing a phrase corresponding to the analyzed context.

In an aspect of the present disclosure, a method for personalizing document search and creating a new document using artificial intelligence performed by a processor of an apparatus includes obtaining first data including a search history of a user, a document viewing history, department information, and an electronic document through an input module; preprocessing the first data; learning the preprocessed first data; generating a document search personalization and new document creation model using the learning result; obtaining a request message through the input module; generating at least one of a document search result and a new document corresponding to the request message using the document search personalization and new document creation model; and controlling the display to display the generated result.

In addition, a computer program stored in a computer-readable recording medium may be further provided to execute a method for implementing the present disclosure.

In addition, a computer-readable recording medium recording a computer program for executing a method for implementing the present disclosure may be further provided.

### BRIEF DESCRIPTION OF THE FIGURES

FIG. 1 is a schematic diagram of an apparatus for personalizing document search and creating a new document within an institution using artificial intelligence according to the present disclosure.

FIG. 2 is a diagram illustrating a flow chart of a method for personalizing document search and creating a new document within an institution using artificial intelligence according to the present disclosure.

FIG. 3 is a diagram illustrating an embodiment of a document search personalization and new document creation UX according to the present disclosure.

FIGS. 4A and 4B are diagrams illustrating the concept of the document search personalization and new document creation according to the present disclosure.

FIG. 5 is a diagram of an embodiment of user profile creation according to the present disclosure.

FIG. 6 is a diagram illustrating an embodiment of collaborative filtering processing according to the present disclosure.

FIG. 7 is a diagram illustrating an example of content-based filtering according to the present disclosure.

FIG. 8 is a diagram illustrating an embodiment considering a temporal context according to the present disclosure.

FIG. 9 is a diagram illustrating an example of applying machine learning according to the present disclosure.

FIG. 10 is a diagram illustrating an example of a template recommendation according to the present disclosure.

FIG. 11 is a diagram illustrating an example of automatic summarization and citation according to the present disclosure.

FIG. 12 is a diagram illustrating an embodiment of keyword extraction according to the present disclosure.

FIG. 13 is a diagram illustrating an embodiment of context-based automatic completion according to the present disclosure.

FIG. 14 is a diagram illustrating an embodiment of real-time related document recommendation according to the present disclosure.

### DETAILED DESCRIPTION

In the drawings, the same reference numeral refers to the same element. This disclosure does not describe all elements of embodiments, and general contents in the technical field to which the present disclosure belongs or repeated contents of the embodiments will be omitted. The terms, such as “unit, module, member, and block” may be embodied as hardware or software, and a plurality of “units, modules, members, and blocks” may be implemented as one element, or a unit, a module, a member, or a block may include a plurality of elements.

Throughout this specification, when a part is referred to as being “connected” to another part, this includes “direct connection” and “indirect connection”, and the indirect connection may include connection via a wireless communication network. Furthermore, when a certain part “includes” a certain element, other elements are not excluded unless explicitly described otherwise, and other elements may in fact be included.

Furthermore, when a certain part “includes” a certain element, other elements are not excluded unless explicitly described otherwise, and other elements may in fact be included.

In the entire specification of the present disclosure, when any member is located “on” another member, this includes a case in which still another member is present between both members as well as a case in which one member is in contact with another member.

The terms “first,” “second,” and the like are just to distinguish an element from any other element, and elements are not limited by the terms.

The singular form of the elements may be understood into the plural form unless otherwise specifically stated in the context.

Identification codes in each operation are used not for describing the order of the operations but for convenience of description, and the operations may be implemented differently from the order described unless there is a specific order explicitly described in the context.

Hereinafter, operation principles and embodiments of the present disclosure will be described with reference to the accompanying drawings.

The present disclosure in this specification may be implemented not only as a server system but also as various devices capable of performing computational processing and providing results to a user. For example, the present disclosure may include all of a computer, a server device, and a portable terminal, or can be in the form of one of them.

Here, the computer may include, for example, a notebook, a desktop, a laptop, a tablet PC, a slate PC, and the like mounted with a web browser.

The server device is a server that communicates with an external device to process information, and may include an application server, a computing server, a database server, a file server, a mail server, a proxy server, and a web server.

The portable terminal is a wireless communication device that ensures portability and mobility, and may include all kinds of handheld-based wireless communication devices such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), WiBro (Wireless Broadband Internet) terminal, a smart phone, and the like, and a wearable device such as at least one of a watch, a ring, bracelets, anklets, a necklace, glasses, contact lenses, or a head-mounted device (HMD).

The function related to artificial intelligence according to the present disclosure operates through a processor and a memory. The processor may be composed of one or more processors. At this time, the one or more processors may be a general-purpose processor such as a CPU, an AP, a DSP (Digital Signal Processor), a graphics-only processor such as a GPU, a VPU (Vision Processing Unit), or an artificial intelligence-only processor such as an NPU. The one or more processors control input data to be processed according to a predefined operation rule or artificial intelligence model stored in the memory. Alternatively, in the case that the one or more processors are artificial intelligence-only processors, the artificial intelligence-only processor may be designed as a hardware structure specialized for processing a specific artificial intelligence model.

The predefined operation rule or artificial intelligence model may be created through learning. Here, being created through learning means that a basic artificial intelligence model is learned by using a plurality of learning data by a learning algorithm, thereby creating a predefined operation rule or artificial intelligence model set to perform a desired characteristic (or, purpose). Such learning may be performed on the device itself in which the artificial intelligence according to the present disclosure is performed, or may be performed through a separate server and/or system. Examples of learning algorithms include supervised learning, unsupervised learning, semi-supervised learning, or reinforcement learning, but are not limited to the examples described above.

The artificial intelligence model may include a plurality of neural network layers. Each of the plurality of neural network layers has a plurality of weights, and performs neural network operations through operations between the operation results of the previous layer and the plurality of weights. The plurality of weights of the plurality of neural network layers may be optimized by the learning results of the artificial intelligence model. For example, the plurality of weights may be updated so that the loss value or cost value acquired by the artificial intelligence model is reduced or minimized during the learning process. The artificial neural network may include a deep neural network (DNN), for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, but is not limited to the examples described above.

The processor may generate a neural network, (train or learn) a neural network, perform a calculation based on received input data, generate an information signal based on the result of the calculation, or retrain the neural network.

The neural network may include CNN (Convolutional Neural Network), RNN (Recurrent Neural Network), percept, multilayer perceptron, FF (Feed Forward), RBF (Radial Basis Network), DFF (Deep Feed Forward), LSTM (Long Short Term Memory), Gated Recurrent Unit (GRU), Auto Encoder (AE), Variational Auto Encoder (VAE), Denoising Auto Encoder (DAE), Sparse Auto Encoder (SAE), Markov Chain (MC), Hopfield Network (HN), Boltzmann Machine (BM), Restricted Boltzmann Machine (RBM), Depp Belief Network (DBN), Deep Convolutional Network (DCN), Deconvolutional Network (DN), Deep Convolutional Inverse Graphics Network (DCIGN), Generative Adversarial Network (GAN), Liquid State Machine (LSM), Extreme Learning Machine (ELM), Echo State Network (ESN), Deep Residual Network (DRN), Differentiable Neural Computer (DNC), Neural Turning Machine (NTM), Capsule Network (CN), Kohonen Network (KN), and Attention Network (AN), but not limited thereto, and it will be understood by those skilled in the art that any neural network may be included.

According to an exemplary embodiment of the present disclosure, the processor may use various artificial intelligence structures and algorithms such as CNN (Convolution Neural Network), R-CNN (Region with Convolution Neural Network), RPN (Region Proposal Network), RNN (Recurrent Neural Network), S-DNN (Stacking-based deep Neural Network), S-SDNN (State-Space Dynamic Neural Network), Deconvolution Network, DBN (Deep Belief Network), RBM (Restricted Boltzmann Machine), Fully Convolutional Network, LSTM (Long Short-Term Memory) Network, Classification Network, Generative Modeling, explainable AI, Continual AI, Representation Learning, and AI for Material Design such as GoogleNet, AlexNet, VGG Network, BERT, SP-BERT, MRC/QA, Text Analysis, Dialog System, GPT-3, and GPT-4 for natural language processing, Visual Analytics, Visual Understanding, Video Synthesis for vision processing, Anomaly Detection, Prediction, Time-Series Forecasting, Optimization, and Recommendation for algorithms ResNet for data intelligence, but not limited thereto. Hereinafter, embodiments of the present disclosure will be described in detail with reference to the attached drawings.

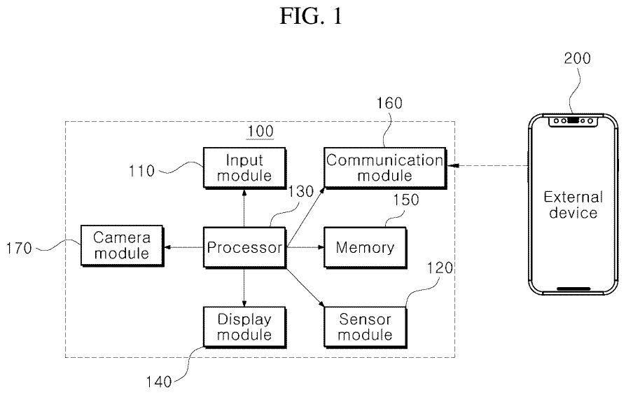

FIG. 1 is a schematic diagram of an apparatus for personalizing document search and creating a new document within an institution using artificial intelligence according to the present disclosure.

Referring to FIG. 1, a document search personalization and new document creation apparatus 100 includes an input module 110, a sensor module 120, a processor 130, a display module 140, a memory 150, a communication module 160, and a camera module 170.

The input module 110 obtains data.

The sensor module 120 senses data.

The processor 130 performs a control method according to a process.

The processor 130 obtains first data including a search history of a user, a document viewing history, department information, and an electronic document through the input module 110, preprocesses the first data, learns the preprocessed first data, generates a document search personalization and new document creation model using the learning result, obtains a request message through the input module 110, generates at least one of a document search result or a new document corresponding to the request message using the document search personalization and new document creation model, and controls the display 140 to display the generated result.

The processor 130 performs preprocessing by converting unstructured data into text through OCR, voice-to-text conversion, and the like, and performing text normalization, stopword removal, and morphological analysis.

The display module 140 displays a graphic image according to a control command from the processor 130.

The memory 150 stores at least one process for performing an operation and stores a user input and data.

The communication module 160 transmits and receives data with an external device 200.

Here, the external device 200 includes an external device such as a smartphone, a PC, a laptop, a tablet PC, and the like.

The camera module 170 captures an image in front.

The camera module 170 photographs a subject in front according to a control command from the processor 130.

The processor 130 may provide a search result optimized for each individual by considering a search pattern, an interest, work characteristics, and the like of the user. In this case, at least one of BERT, GPT, or Llama3.1 may be utilized.

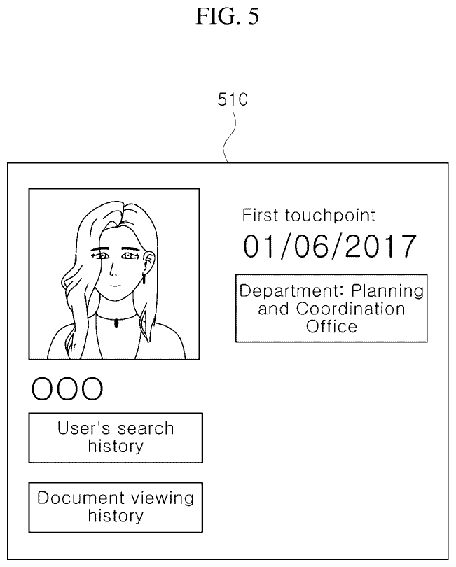

The processor 130 controls the display 140 to display the generated individual profile, which is generated based on at least one of the search history of the user, the document viewing history, or the department information. A detailed description thereof is described in FIG. 5.

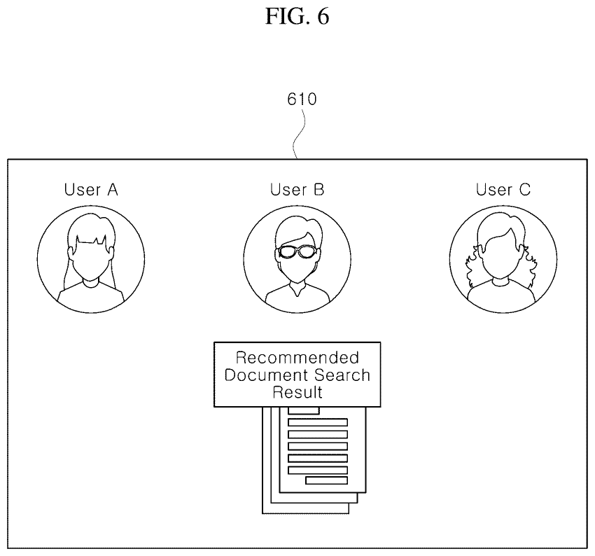

The processor 130 generates a recommended document search result by analyzing search patterns of users performing similar tasks, and controls the display to display the generated recommended document search result. A detailed description thereof is described in FIG. 6.

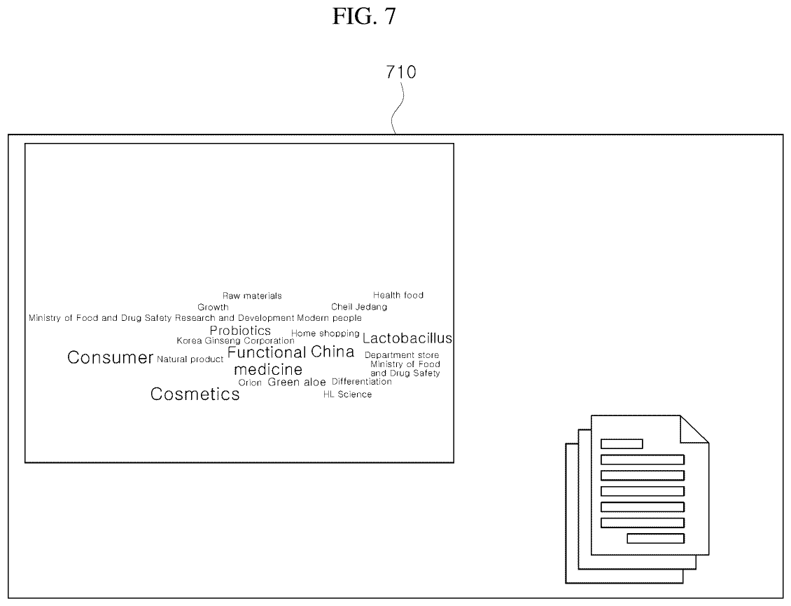

The processor 130 analyzes a keyword and a topic of the document viewed by the user within a predetermined period, and controls the display to display the document with a similarity exceeding a threshold based on the analysis result. A detailed description thereof is described in FIG. 7.

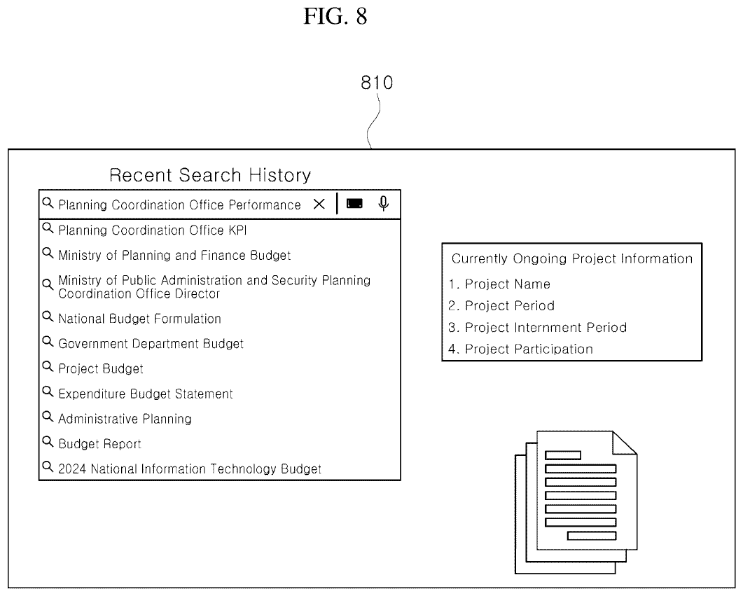

The processor 130 controls control the display 140 to display the document with a relevance exceeding a threshold by reflecting recent search history and information on current proceeding project. A detailed description thereof is described in FIG. 8.

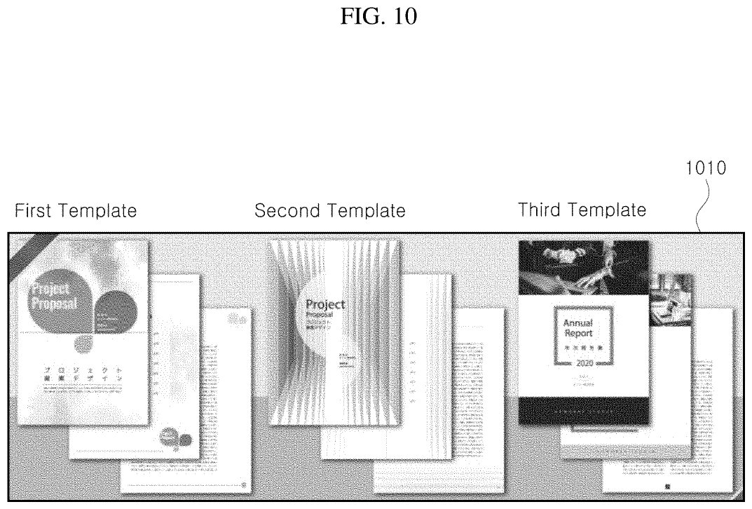

The processor 130 searches for a related document of which similarity level with the new document is a predetermined range or higher, analyzes a structure of the searched similar document, and controls when creating the new document. A detailed description thereof is described in FIG. 10.

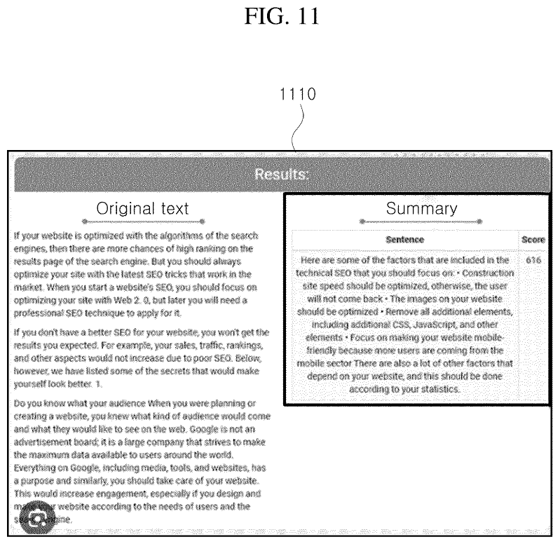

The processor 130 searches for a related document of which similarity level with the new document is a predetermined range or higher, automatically summarizes and cites a core content of the related document, and controls the display 140 to display the summary and citation result. A detailed description thereof is described in FIG. 11.

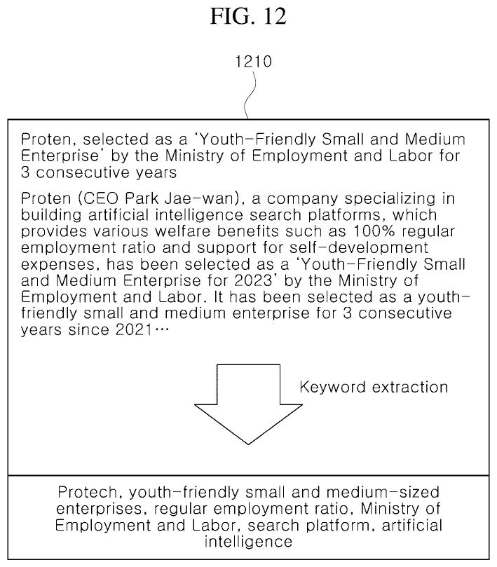

The processor 130 searches for a related document of which similarity level with the new document is a predetermined range or higher, extracts a main keyword of the related document, and controls the display to display the extracted main keywords. A detailed description thereof is described in FIG. 12.

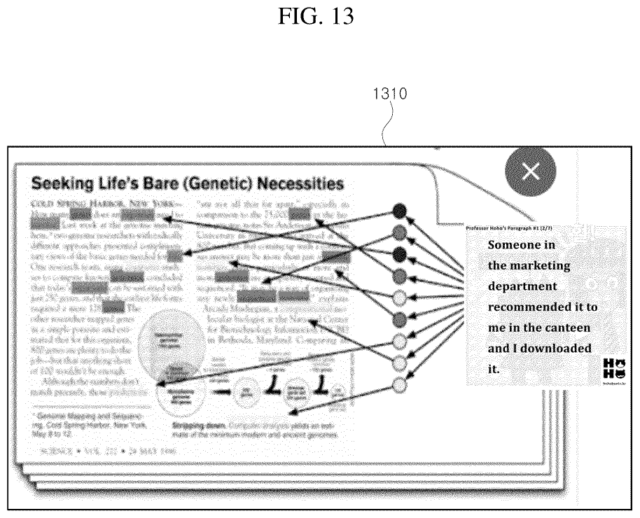

The processor 130 analyzes a context of the document being written and controls the display 140 to display a text message containing a phrase corresponding to the analyzed context. A detailed description thereof is provided in FIG. 13.

However, the components illustrated in FIG. 1 are not essential for implementing the present disclosure according to the present disclosure, and thus the present disclosure described in this specification may have more or fewer components than the components listed above.

The communication module 160 may include one or more components that enable communication with an external device, and may include, for example, at least one of a broadcast reception module, a wired communication module, a wireless communication module, a short-range communication module, or a location information module.

The input module 110 is for inputting image information (or a signal), audio information (or a signal), data, or information input from a user, and may include at least one camera, at least one microphone, and at least one of a user input unit. Voice data or image data collected by the input module 110 may be analyzed and processed as a user control command.

The display 140 displays (outputs) information processed in the present disclosure. For example, the present disclosure may display execution screen information of an application program (for example, an application) being driven, or UI (User Interface), GUI (Graphical User Interface) information according to such execution screen information.

The memory 150 may store data supporting various functions of the present disclosure, programs for the operation of the control unit, may store input/output data (e.g., music files, still images, moving images, etc.), and may store a plurality of application programs or applications driven by an artificial intelligence-based user behavior pattern analysis device 100, data for the operation of the device, and commands. At least some of these application programs may be downloaded from an external server via wireless communication.

The memory 150 may include at least one type of storage medium among a flash memory type, a hard disk type, an SSD type (Solid State Disk type), an SDD type (Silicon Disk Drive type), a multimedia card micro type, a card type memory (e.g., an SD or XD memory, etc.), RAM (random access memory), SRAM (static random access memory), ROM (read-only memory), EEPROM (electrically erasable programmable read-only memory), PROM (programmable read-only memory), a magnetic memory, a magnetic disk, and an optical disk. In addition, the memory 150 may be a database connected by wire or wirelessly, although separate from the present disclosure, and may be implemented as a database system.

The processor 130 may be implemented as at least one processor (not shown) that includes at least one core, stores data for an algorithm for controlling the operation of components within the present disclosure or a program that reproduces the algorithm, and performs the aforementioned operation using the data stored in the memory. At this time, the memory and the processor may be implemented as separate chips. Alternatively, the memory and the processor may be implemented as a single chip.

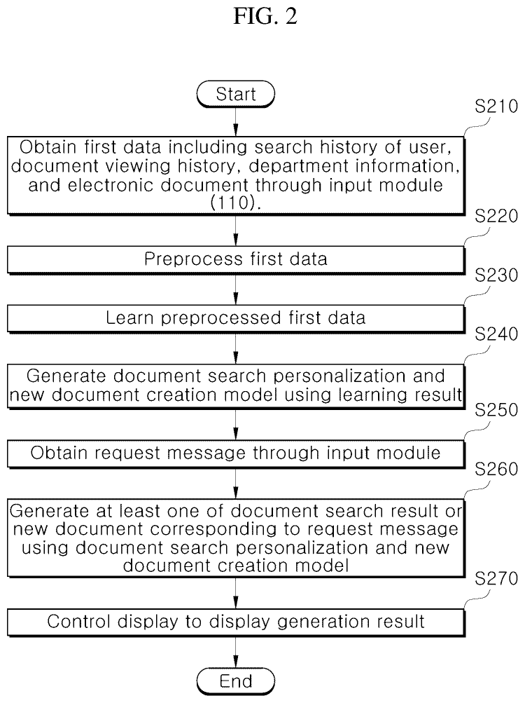

In addition, the processor 130 may control one or a combination of the components discussed above in order to implement various embodiments according to the present disclosure described in FIGS. 2 to 14 below.

At least one component may be added or deleted in accordance with the performance of the components illustrated in FIG. 1. In addition, it will be readily understood by those skilled in the art that the mutual positions of the components may be changed in accordance with the performance or structure of the system.

Meanwhile, each component illustrated in FIG. 1 means a software and/or hardware component such as a Field Programmable Gate Array (FPGA) and an Application Specific Integrated Circuit (ASIC).

FIG. 2 is a diagram illustrating a flow chart of a method for personalizing document search and creating a new document within an institution using artificial intelligence according to the present disclosure.

The present disclosure is performed by the document search personalization and new document creation apparatus 100 or the processor 130 of the document search personalization and new document creation apparatus 100.

Referring to FIG. 2, the processor 130 obtains first data including a search history of a user, a document viewing history, department information, and an electronic document through the input module 110 (step S210).

The processor 130 preprocesses the first data (step S220).

The processor 130 learns the preprocessed first data (step S230).

The processor 130 generates a document search personalization and new document creation model using the learning result (step S240).

The processor 130 obtains a request message through the input module (step S250).

The processor 130 generates at least one of a document search result or a new document corresponding to the request message using the document search personalization and new document creation model (step S260).

The processor 130 controls the display 140 to display the generation result (step S270).

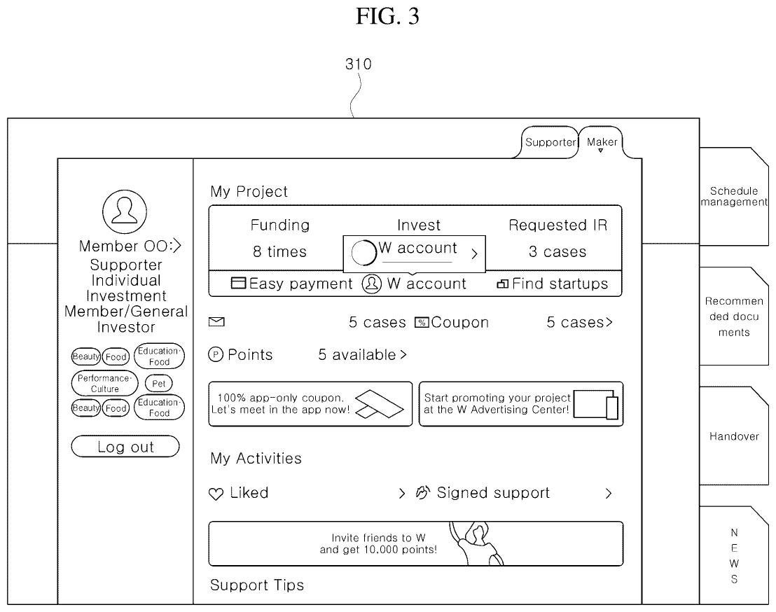

FIG. 3 is a diagram illustrating an embodiment of a document search personalization and new document creation UX according to the present disclosure.

Referring to FIG. 3 (310), the document search personalization and new document creation UX are described.

The document search personalization and new document creation item include a schedule management, a recommended document, a handover, and a News item.

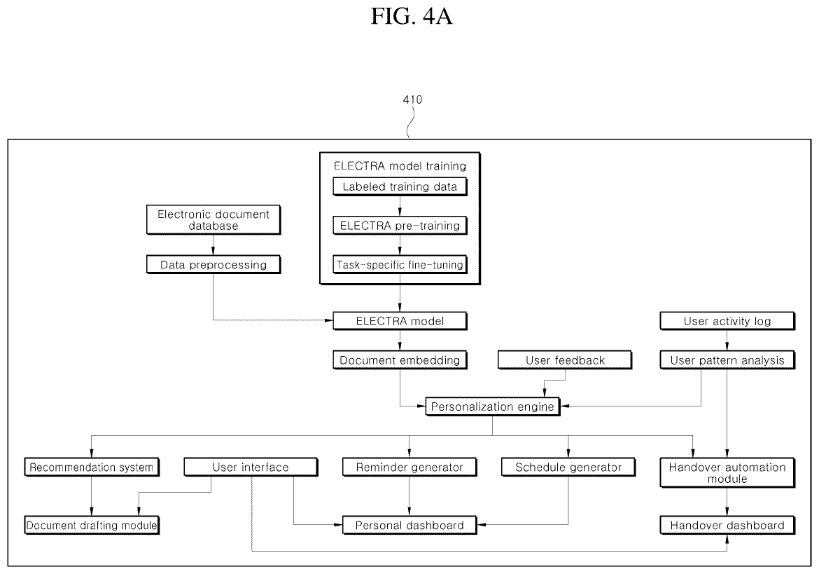

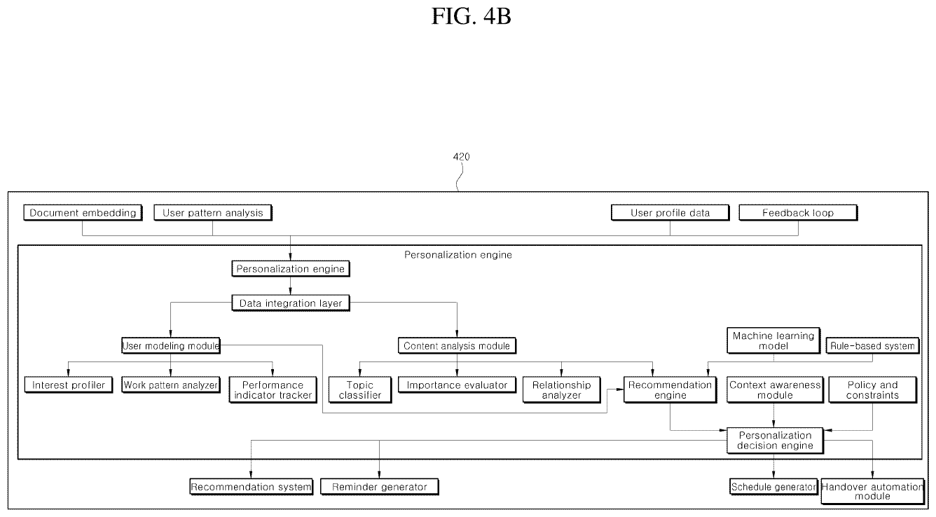

FIGS. 4A and 4B are diagrams illustrating the concept of the document search personalization and new document creation according to the present disclosure.

FIG. 4A (410) is a diagram illustrating the first concept of the document search personalization and new document creation.

FIG. 4B (420) is a diagram illustrating the second concept of the document search personalization and new document creation.

The processor 130 includes a record management system linkage module, a data preprocessing and refinement module, a BERT-based context embedding engine, an SLM (Supervised Language Model) configuration module, a multi-task learning module, an intelligent task automation engine, a personalized recommendation and search module, an adaptive learning and model update module, an explainable AI dashboard, a security and compliance module, and an extensible microservice architecture.

The individual modules included in the processor 130 perform the following:
(1) The record management system linkage module safely links with the existing record management system of a public institution and collects and integrates records in various formats (documents, images, voices, etc.).
(2) The data preprocessing and refinement module converts unstructured data into text through OCR, voice-to-text conversion, and the like, and performs text normalization, stopword removal, and morphological analysis.
(3) The BERT-based context embedding engine utilizes a pre-learning model such as KoBERT optimized for Korean, and generates high-dimensional vector representations that consider the context and meaning of record.
(4) The SLM (Supervised Language Model) configuration module receives the output of BERT as an input, builds a language model specialized for public institutions, and performs supervised learning that combines the metadata and content of record.
(5) The multi-task learning module simultaneously learns various NLP tasks such as document classification, information extraction, and relationship analysis, and adds a custom task specialized for record management (e.g., preservation period prediction).
(6) The intelligent business automation engine automatically classifies documents and generates metadata, performs association analysis of record and build knowledge graph, and supports business process automation and decision-making.
(7) The personalized recommendation and search module may recommend customized records considering the user's work pattern and access right, and provide semantic-based advanced search and Q&A function.
(8) The adaptive learning and model update module continuously updates the model reflecting user feedback and new record, and performs model-specific functions reflecting the characteristics of each institution and department.
(9) The explainable AI dashboard provides an evidence for the model's recommendation and classification result, and performs visualization of record utilization pattern and insight.
(10) The security and compliance module may apply thorough access control and encryption, and ensure compliance with the Personal Information Protection Act and the Public Records Management Act.
(11) The extensible microservice architecture supports flexible integration with various public institution records management systems, and secures scalability and stability in a cloud-native environment.

FIG. 5 is a diagram of an embodiment of user profile creation according to the present disclosure.

As illustrated in FIG. 5 (510), the processor 130 creates an individual profile based on at least one of the search history of the user, the document viewing history, or the department information, and controls the display 140 to display the created individual profile.

For example, the processor 130 creates the individual profile based on at least one of the search history of the user, the document viewing history, or the Planning and Coordination Office.

Here, the search history of the user includes the Planning and Coordination Office KPI, the Planning and Finance Office budget, the Planning and Coordination Office Director of the Ministry of Public Administration and Security, national budget formation, government department budget, business budget, expenditure budget statement, administrative planning, budget report, and the 2024 national information technology budget.

The processor 130 stores a search pattern used by each user in memory. For example, the memory stores search keywords, personal keywords, document usage patterns, and the like.

The processor 130 obtains a department name by referencing a document. Each document contains a department name.

The processor 130 maps all search keywords to personal user IDs.

The processor 130 stores all search keywords in memory 150.

In the case that the departments are A, B, and C, the document produced by department A becomes document a.

The document produced by department B becomes document b.

The document produced by department C becomes document c.

Document A, Document B, and Document C are checked whether they are related to the user's work, and in the case that the relatedness is 80% or higher, they are connected.

The relatedness is composed of 0 to 100%. 0 means that there is a relatedness, and 100% means that the relatedness is very high.

According to one embodiment, a frequently viewed document may be recommended by comparing search result.

Search results show document A with a 70% probability.

Search results show document B with a 30% probability.

Therefore, the processor 130 may recommend document A with a higher probability.

FIG. 6 is a diagram illustrating an embodiment of collaborative filtering processing according to the present disclosure.

As illustrated in FIG. 6 (610), the processor 130 analyzes search patterns of users performing similar tasks to generate recommended document search result, and controls the display 140 to display the recommended document search result.

For example, the search patterns of other users, such as user A, user B, and user C, performing similar tasks to the user are analyzed to generate recommended document search result.

The recommended document search result may be provided in the form of ranking.

For example, the recommended document corresponding to user A may be ranked 1st, the recommended document corresponding to user B may be ranked 2nd, and the recommended document corresponding to user C may be ranked 3rd.

FIG. 7 is a diagram illustrating an example of content-based filtering according to the present disclosure.

As shown in FIG. 7 (710), the processor 130 analyzes a keyword and a topic of the document viewed by the user within a predetermined period, and controls the display 140 to display the document with a similarity exceeding a threshold based on the analysis result.

For example, the keyword and the topic include at least one of a consumer, a functional medicine, lactic acid bacteria, or cosmetics.

The processor 130 controls the display to display the document with a similarity greater than 80% based on the analysis result.

The similarity may be 0% to 100%, with 0% meaning no relevance and 100% meaning very high relevance.

FIG. 8 is a diagram illustrating an embodiment considering a temporal context according to the present disclosure.

As illustrated in FIG. 8 (810), the processor 130 controls the display 140 to display the document with a relevance exceeding a threshold by reflecting recent search history and information on current proceeding project.

For example, in the case of recent search history, the user's search record includes the Planning and Coordination Office KPI, the Planning and Finance Office Budget, the Planning and Coordination Office Director of the Ministry of the Interior and Safety, the National Budget Formulation, the government department budget, the business budget, the expenditure budget statement, the administrative planning, the budget report, and the 2024 National Information Technology Budget.

The information on the currently ongoing project is a project name, a project period, a project participation period, and a project participation.

The threshold value of this article is 0.80.

Similarity may be 0 to 1.0, 0% means no relevance, 100% means very high relevance.

In the case that the relevance is 0.75, the processor 130 does not display the document.

In the case that the relevance is 0.85, the processor 130 displays the document.

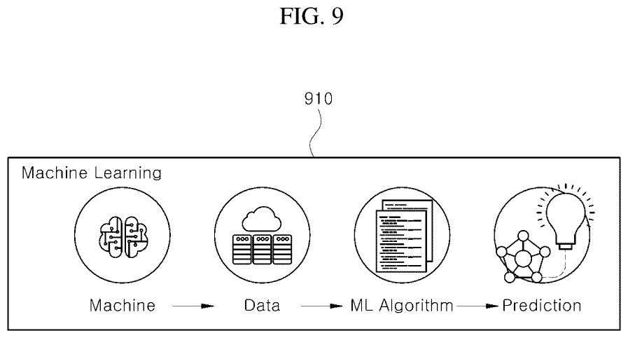

FIG. 9 is a diagram illustrating an example of applying machine learning according to the present disclosure.

The processor 130 performs learning by applying a machine learning model.

For example, the processor 130 learns a user feedback by applying a machine learning model.

Here, the user feedback includes a click rate, a document opening time, and the like.

FIG. 10 is a diagram illustrating an example of a template recommendation according to the present disclosure.

As illustrated in FIG. 10 (1010), when creating the new document, the processor 130 searches for a similar document of which content and similarity to the new document is within a predetermined range or higher, analyzes a structure of the searched similar document, and controls the display 140 to display a template that reflects the analysis result.

The similarity may be 0% to 100%, where 0% means no relevance and 100% means very high relevance.

The processor 130 searches for a similar document of which similarity is 80% or higher, and analyzes the structure of the similar document.

In the case that the structure of the similar document is template 1, template 2, or template 3, the processor 130 displays them sequentially.

FIG. 11 is a diagram illustrating an example of automatic summarization and citation according to the present disclosure.

As illustrated in FIG. 11 (1110), the processor 130 searches for a related document of which similarity level with the new document is a predetermined range or higher, automatically summarizes and cites a core content of the related document, and controls the display 140 to display the summary and citation result.

The processor 130 searches for a document having a similarity of 80% or higher with the new document, and automatically summarizes the core content of the document.

The processor 130 may summarize the summary range to 80%, 70%, and 10% of the original text. In addition, the processor 130 may summarize the original context to 150 words and 100 words.

The processor 130 may summarize the entire topic into one sentence.

FIG. 12 is a diagram illustrating an embodiment of keyword extraction according to the present disclosure.

As illustrated in FIG. 12 (1210), the processor 130 searches for a related document of which similarity level with the new document is a predetermined range or higher, extracts a main keyword of the related document, and controls the display to display the extracted main keyword.

The processor 130 extracts keywords from the related document.

Here, the main keyword includes Proten, Youth-Friendly Small and Medium Enterprise, Regular Employment Ratio, Ministry of Employment and Labor, Search Platform, and Artificial Intelligence.

FIG. 13 is a diagram illustrating an embodiment of context-based automatic completion according to the present disclosure.

As shown in FIG. 13 (1310), the processor 130 analyzes a context of the document being written and controls the display 140 to display a text message including a phrase corresponding to the analyzed context.

For example, the processor 130 analyzes the context of the document being written.

The processor 130 analyzes the context centered on the subject, predicate, and object of the sentence included in the document.

In the case that the document is a foreign language document, the processor 130 analyzes the context centered on the noun, verb, adjective, and pronoun of the sentence.

For example, the text message corresponding to the context includes the content “Someone in the marketing department recommended it to me in the canteen and I downloaded it”.

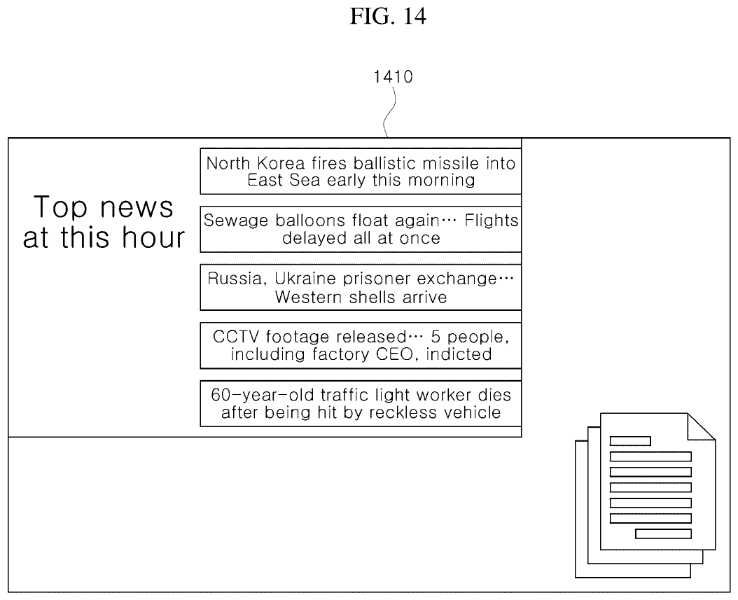

FIG. 14 is a diagram illustrating an embodiment of real-time related document recommendation according to the present disclosure.

As illustrated in FIG. 14 (1410), the processor 130 searches for real-time news and selects a document of which similarity to the subject of the document currently being written is greater than a threshold, and controls the display 140 to display the selected document.

For example, the processor 130 searches for real-time news and selects a document of which similarity to the subject of the document currently being written is greater than 80%.

The real-time news includes real-time major news.

The range of similarity may be 0 to 100%.

According to one embodiment of the present disclosure, legal information may be linked and displayed.

The processor 130 may search for legal information with a similarity greater than a threshold value in relation to the subject of the document currently being written, and control the display 140 to display the searched legal information.

For example, in the case that the subject of the document is a trademark non-registration reason, the processor 130 searches for trademark laws with a similarity greater than 80%, and the display 140 displays the searched trademark law provisions on the screen.

According to the present disclosure, it is possible to provide search results optimized for each individual by considering the user's search pattern, interest, work characteristics, and the like, so that user convenience may be improved.

According to the present disclosure, it is possible to search and recommend documents required by a specific user through electronic document learning, so that user convenience may be improved.

According to the present disclosure, it is possible to create a new draft document by editing by directly utilizing a draft document required for a specific task of the user, so that user convenience may be improved.

The various embodiments of the present disclosure are not intended to list all possible combinations but rather to illustrate representative aspects of the present disclosure, and the matters described in the various embodiments may be applied independently or in combinations of two or more.

1. An apparatus for personalizing document search and creating a new document within an institution using artificial intelligence, comprising:
an input module configured to acquire data;
a communication module configured to transmit and receive the data with an external device;
a memory configured to store at least one process for performing an operation and storing user input and data;
a display configured to display a graphic image; and
a processor configured to perform a control method according to the process,
wherein the processor is configured to:
obtain first data including a search history of a user, a document viewing history, department information, and an electronic document through the input module,
preprocess the first data,
learn the preprocessed first data,
generate a document search personalization and new document creation model using the learning result,
obtain a request message through the input module,
generate at least one of a document search result or a new document corresponding to the request message using the document search personalization and new document creation model, and
control the display to display the generated result,
wherein the processor is further configured to:
learn a user feedback, which include a click rate and a document opening time, by applying a machine learning model, to generate the learning result,
wherein the processor is further configured to:
based on the new document creation model, search for a similar document of which content and similarity to the new document is within a predetermined range or higher;
analyze a structure of the searched similar document; and
control the display to sequentially display a plurality of templates, which reflect the analysis result, and
wherein the processor is further configured to:
search for real-time news and select a document of which similarity to a subject of the document currently being written is greater than a threshold, and control the display to display the selected document.

2. The apparatus of claim 1, wherein the processor is configured to:
generate a personal profile based on at least one of the search history of the user, the document viewing history, or the department information, and
control the display to display the generated personal profile.

3. The apparatus of claim 1, wherein the processor is configured to:
generate a recommended document search result by analyzing search patterns of users performing similar tasks, and
control the display to display the generated recommended document search result.

4. The apparatus of claim 1, wherein the processor is configured to:
analyze a keyword and a topic of the document viewed by the user within a predetermined period, and
control the display to display the document with a similarity exceeding a threshold based on the analysis result.

5. The apparatus of claim 1, wherein the processor is configured to:
control the display to display the document with a relevance exceeding a threshold by reflecting recent search history and information on current proceeding project.

6. (canceled)

7. The apparatus of claim 1, wherein the processor is configured to:
search for a related document of which similarity level with the new document is a predetermined range or higher,
automatically summarize and cite a core content of the related document, and
control the display to display the summary and citation result.

8. The apparatus of claim 1, wherein the processor is configured to:
search for a related document of which similarity level with the new document is a predetermined range or higher,
extract a main keyword of the related document, and
control the display to display the extracted main keyword.

9. The apparatus of claim 1, wherein the processor is configured to:
analyze a context of the document being written, and
control the display to display a text message containing a phrase corresponding to the analyzed context.

10. A method for personalizing document search and creating a new document using artificial intelligence performed by a processor of an apparatus, comprising:
obtaining first data including a search history of a user, a document viewing history, department information, and an electronic document through an input module;
preprocessing the first data;
learning the preprocessed first data;
generating a document search personalization and new document creation model using the learning result;
obtaining a request message through the input module;
generating at least one of a document search result and a new document corresponding to the request message using the document search personalization and new document creation model; and
controlling a display to display the generated result,
wherein the learning comprises:
learning a user feedback, which include a click rate and a document opening time, by applying a machine learning model, to generate the learning result,
wherein the controlling comprises:
based on the new document creation model, searching for a similar document of which content and similarity to the new document is within a predetermined range or higher;
analyzing a structure of the searched similar document; and
controlling the display to sequentially display a plurality of templates, which reflect the analysis result, and
wherein the controlling further comprises:
searching for real-time news and select a document of which similarity to a subject of the document currently being written is greater than a threshold, and controlling the display to display the selected document.

11. The apparatus of claim 1, wherein the processor is further configured to search for legal information with a similarity greater than a threshold value in relation to the subject of the document currently being written, and control the display to display the searched legal information.

12. The method of claim 10, wherein the controlling further comprises:
searching for legal information with a similarity greater than a threshold value in relation to the subject of the document currently being written, and controlling the display to display the searched legal information.
